(19) United States
(12) Patent Application Publication
(10) Pub. No.: US 2013/0320168 A1
(43) Pub. Date: Dec. 5, 2013

(54) MOUNTING BRACKET FOR SUPPORTING AN ARTICLE

(71) Applicants: Samuel R. Peacemaker, Spokane, WA (US); Luke A. Kresek, Tonasket, WA (US); Landon D. Becker, Tonasket, WA (US); Tyrel D. Becker, Tonasket, WA (US); Benjamin R. Peacemaker, Tonasket, WA (US); Zachary J. Peacemaker, Tonasket, WA (US)

(72) Inventors: Samuel R. Peacemaker, Spokane, WA (US); Luke A. Kresek, Tonasket, WA (US); Landon D. Becker, Tonasket, WA (US); Tyrel D. Becker, Tonasket, WA (US); Benjamin R. Peacemaker, Tonasket, WA (US); Zachary J. Peacemaker, Tonasket, WA (US)

(21) Appl. No.: 13/482,120

(22) Filed: May 29, 2012

(51) Int. Cl. F16M 13/02; F16M 13/00

(52) U.S. Cl. 248/226.11; 248/316.1; 248/231.9; 248/292.12

(57) ABSTRACT

A mounting bracket having upper and lower portions, secure and transport portable tubular metal animal corrals along the outside of an animal trailer or other overland vehicle, and wherein the upper portion is mounted on one of the sides of the animal trailer or overland vehicle, and is capable of supporting a portion of the tubular metal portable animal enclosure, and wherein the lower portion is mounted in spaced relation relative to the upper portion, and is further operable to receive, and releasably clamp into place, another portion of the tubular metal portable animal enclosure.

### TECHNICAL FIELD

The present invention relates to a mounting bracket for supporting an article, and more particularly to a mounting bracket which find particular utility, and usefulness, in mounting and securing portable animal enclosures to overland vehicles and other structures, having vertically oriented surfaces, such as a barn or the like.

### BACKGROUND OF THE INVENTION

The present invention relates generally to a mounting bracket arrangement for securing an article, such as portable animal enclosures, and which are used for enclosing horses and other large livestock animals. More specifically the invention relates to a mounting bracket arrangement which securely mounts the portable animal enclosures to an animal trailer, vehicle or to the side of a building, such as a barn, when the portable animal enclosures are not in use.

Horses and other livestock animals are frequently transported via trailer to a variety of locations for animal activities ranging from business, to competition to recreation. Unfortunately, many such remote locations do not have suitable enclosures for the horses and/or other livestock. Alternatively, if the location does have animal enclosures, they are sometimes full or not suitable for the needs of the particular animal. Accordingly, the need has arisen for the owner of horse or livestock animals to transport a suitable animal enclosure to remote locations which may be utilized for the animals they are transporting.

Portable metal animal enclosures have been used by those handling horses and livestock animals for many years. Portable metal enclosures are preferred due to the durability of the enclosure and the high-visibility of the individual enclosures to the animal being enclosed. Transporting these animal enclosures has been difficult, due to the size and weight of the respective enclosure pieces, and the number of enclosure pieces required to be transported. Past methodologies for transporting these animal enclosures have included integrating or coupling the animal enclosure with the vehicle used to transport the animal, as seen in U.S. Patent Publication Number 2003/0209207 (Campbell), U.S. Patent Publication Number 2002/0139315 (Calvert), and U.S. Pat. No. 3,726,256 (Bernhardt). The teachings of the above cited patents and patent applications are incorporated herein by reference. However, these integrated systems require the use of a particular animal trailer, which may not be suitable for the user, or the particular occasion or location. Further, the usefulness of the integrated animal enclosure is lost should the animal trailer be sold or damaged.

A possible resolution to the deficiencies noted in the vehicle integrated portable animal enclosure is shown in U.S. Pat. No. 7,325,513 (Velasquez), and which uses pockets and strapping to attach the portable animal enclosure to the side of a particular animal trailer. The teachings of this cited patent is also incorporated herein by reference. However, this cited prior art teaching fails to hold the portable animal enclosures securely in place while they are being transported. Further, when the prior art portable animal enclosure system is not in use, it cannot be conveniently stored, out of the way and, therefore, this deficiency presents a possible source of injury to the animals while they are being enclosed.

While the teachings of the above noted prior art references may be suitable for the particular issues and problems which they respectively address, they are not suitable for securely attaching and efficiently transporting portable animal enclosures to various locations. Current portable animal enclosure transportation systems do not conveniently maintain the portable animal enclosure in a secure position during transport, and cannot be adjusted for variously sized portable animal enclosures. Additionally, the present state of the prior art fails to keep animals safe when these prior art transportation systems are not in use.

The present invention resolves the issues associated with the prior art in that it presents a novel arrangement for transporting portable animal enclosures which securely holds the animal enclosure in place during transport, regardless of the size of the portable animal enclosure. The present invention also resolves the problems associated with animal safety while the portable animal enclosures are in use, and when the new and novel invention is not being utilized.

In the presently disclosed invention, the portable animal enclosures are held securely in place while being transported from location-to-location, regardless of the size of the respective portable animal enclosures. While the portable animal enclosures are in use to enclose a particular animal, such as a horse, the disclosed mounting bracket arrangement conveniently folds out of the way so as to prevent the enclosed animal from injury as might be occasioned as when the animal might brush against the animal trailer, for example.

An invention which avoids many of the shortcomings associated with prior art devices utilized heretofore for similar purposes is the subject matter of the present invention.

### SUMMARY OF THE INVENTION

A first aspect of the present invention relates to a mounting bracket for supporting an article, which includes a first base which is mounted on a supporting surface, and wherein the first base has a first end and a second end; a first mounting member attached to the first base; a second mounting member attached to the first base, and wherein the second mounting member is located in spaced relation relative to the first mounting member; a support arm having a first end and a second end, and wherein the first end is releasably mounted to the first mounting member; an inferior clamp portion having a first end and a second end, and wherein the first end is pivotally attached to the second end of the support arm, and wherein the second end is releasably attached to the second mounting member; a superior clamp portion having a first and a second end, and wherein the first end is pivotally attached to the first end of the inferior clamp portion, and wherein the second end is releasably attached to the second end of the inferior clamp portion, and wherein a portion of an article is received between the inferior and superior clamp portions; a second base mounted on the supporting surface, and in spaced relation relative to the first base, and wherein the second base has opposite first and second ends; a supporting surface mounted on the second base and which extends perpendicularly outwardly relative thereto, and wherein the supporting surface is located intermediate the first and second ends of the second base; and an article supporting member having a proximal and a distal end, and which is mounted on the second base, and to the supporting surface and wherein a portion of the article is supported on the article supporting member.

A second aspect of the present invention relates to a mounting bracket for supporting an article, and which includes an article supporting member for releasably securing an article at a predetermined location on an overland vehicle; a first mounting member affixed on the overland vehicle; a second mounting member affixed on the overland vehicle, and wherein the second mounting member is located in spaced relation relative to the first mounting member; an inferior clamp portion pivotally mounted to the second mounting member and which secures the article in spaced relation relative to the article supporting member; a superior clamp portion pivotally mounted on the inferior clamp portion and which secures the article in spaced relation relative to the article supporting member; and a support arm for maintaining the superior and inferior clamp portions in a predetermined first position or a second position.

Still another aspect of the present invention relates to a mounting bracket for supporting an article, and which includes a first base, having a first and a second end; a first mounting member, mounted on the first base and which is located intermediate the first and second ends thereof, and wherein the first mounting member has a first portion and a second portion; a second mounting member, mounted on the first base and which is located intermediate the first and second ends of the first base and which is further located in spaced relation relative to the first mounting member, and wherein the second mounting member has a first portion and a second portion; a support arm having a first end and a second end, and wherein first end is pivotally mounted on the first mounting member; an inferior clamp portion having a first end and a second end, and wherein the inferior clamp portion receives an article to be supported, and is pivotally mounted to the second end of the support arm; a superior clamp portion, having a first end and a second end, and wherein the superior clamp portion secures, in a predetermined position, the article to be supported, and wherein the first end of the superior clamp portion is pivotally mounted on the second end of the support arm; a second base having a first end, and a second end, and wherein the second base is located in spaced relation relative to the first base; a supporting surface which is mounted on the second base and which is further located intermediate the first and second ends of the second base, and which further extends substantially perpendicularly, outwardly relative thereto; and an article supporting member, which is mounted on the second base and which is located intermediate the first and second ends of the second base, and which is further mounted to the supporting surface, and wherein a portion of the article supporting member supports the article.

Moreover, another aspect of the present invention relates to a mounting bracket for securing an article, and which includes a base which is mounted on a supporting surface, and wherein the base has a first and second end and a first sidewall and a second sidewall; a superior support pin; which matingly engages the first and second sidewall, an inferior support pin; which matingly engages the first and second sidewall and which is further located in predetermined spaced relation relative to the superior support pin; a strap portion having a first end and a distal second end, and wherein the first end of the strap is coupled to the superior support pin; and a ratchet assembly affixed to the inferior support pin and wherein the second end of the strap releasably cooperates with ratchet assembly and forcibly engages the article.

These and other aspects of the present invention will be discussed in greater detail hereinafter.

### BRIEF DESCRIPTION OF THE DRAWINGS

Preferred embodiments of the present invention are described below with reference to the following accompanying drawings.

FIG. 1 is a perspective view of a first form of a lower portion of the present invention, and which is shown in an operationally closed position.

FIG. 2 is a side elevation view of the lower portion of the present invention as seen in FIG. 1, and which is shown in an operationally closed portion.

FIG. 3 is a side elevation view of the lower portion of the present invention as seen in FIG. 1, and which is shown in an operationally open position.

FIG. 4 is a side elevation view of the lower portion of the present invention as seen in FIG. 1, and which is shown in an operationally stored position.

FIG. 5 is a side view of the upper portion of the present invention.

FIG. 6 is a first perspective view of the upper portion of the present invention.

FIG. 7 is a second perspective view of the upper portion of the present invention, and which is taken from a position about 180 degrees offset from that seen in FIG. 6.

FIG. 8 is a greatly simplified, side elevation, environmental view of the present invention and which is shown in a typical operational configuration.

FIG. 9 is a top plan view of a ratchet assembly which forms a feature of a second form of the present invention.

FIG. 10 is a rear plan view of the ratchet assembly as depicted in FIG. 9 of the present invention.

FIG. 11 is an end view of the ratchet assembly as seen in FIG. 9.

FIG. 12 is a side elevation view of the ratchet assembly as seen in FIG. 9.

FIG. 13 is a perspective view of the ratchet assembly as seen in FIG. 9.

FIG. 14 is a perspective, environmental view of the lower portion of the second form of the invention and which is depicted in a storage position.

FIG. 15 is a fragmentary, perspective, environmental view of the lower portion of the second form of the invention and which is depicted in an operational position.

FIG. 16 is a second, fragmentary, perspective, environmental view of the second form of the prevent invention, and which is depicted in an operational position to secure a plurality of animal enclosures on an overland vehicle.

FIG. 17 is a third, perspective, environmental view of the second form of the present invention, and which is illustrated in an operational position and securing a multiplicity of animal enclosures on an overland vehicle.

FIG. 18 is a perspective, environmental view, of a lower portion of a third form of the present invention.

### DETAILED DESCRIPTION OF THE PREFERRED EMBODIMENTS

This disclosure of the present invention is submitted in furtherance of the Constitutional purposes of the U.S. Patent Laws “to promote the progress of science and the useful arts.” Article 1, Section 8.

### First Embodiment

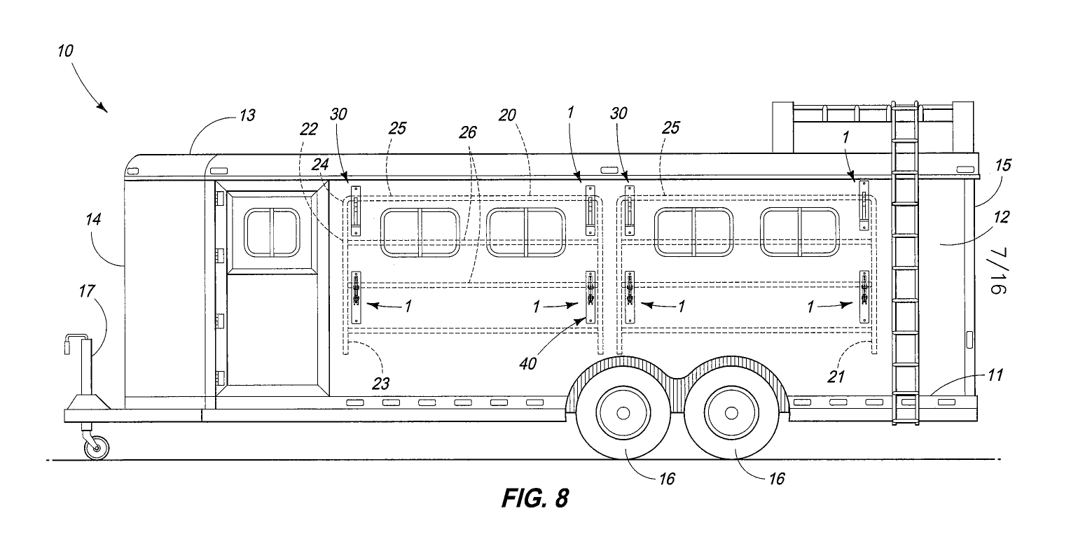

Referring now to FIG. 8, a first form of the invention 1 is shown in a typical operational environment. In this view an animal trailer 10 of conventional design is depicted, and which is carrying or supporting a multiplicity of corral panel portions 20 (shown in phantom lines). Further, the present invention 1 is shown and which has an upper portion 30, and a lower portion 40 which securely engages and supports the corral panel portions on the animal trailer 10.

The animal trailer 10, as illustrated, is preferably a commercially available trailer which is used to transport horses, and other large livestock animals. The trailer 10 is configured to be pulled by another towing vehicle (not shown). The animal trailer 10 has a floor 11, oppositely spaced rigid sidewalls 12, a roof 13, a rigid front panel 14, and rear doors 15. The animal trailer 10 has earth engaging wheels 16, for movement across the surface of the earth, and a trailer tongue 17 for releasably attaching the animal trailer 10 to a towing overland vehicle (not shown). The animal trailer 10 is typically constructed of rigid metal or similar material and which has sufficient strength to support the combined weight of the animals being transported, and the corral panel portions 20 which are releasably attached to the exterior of the animal trailer 10.

The corral panel portions 20 include an earth engaging base member 21, supporting legs 22, each having a proximal end 23 and a distal end 24; a top horizontal member 25, and a multiplicity of spaced, generally horizontally oriented members 26, which are located intermediate the proximal end 23 and the distal end 24 of the perspective supporting legs 22. The corral panel portions 20 typically each have barrel hinge members (not shown) for connecting the corral panel portions 20 to each other when the corral panel portions 20 are being employed to enclose a particular animal. The corral panel portions 20 are typically constructed of tubular metal of sufficient strength to withstand repetitive disassembly, transport, and reassembly and to be highly visible to the animal being enclosed. Typically the enclosure formed to hold the animals being transported may include the wall 12 of the overland trailer 10.

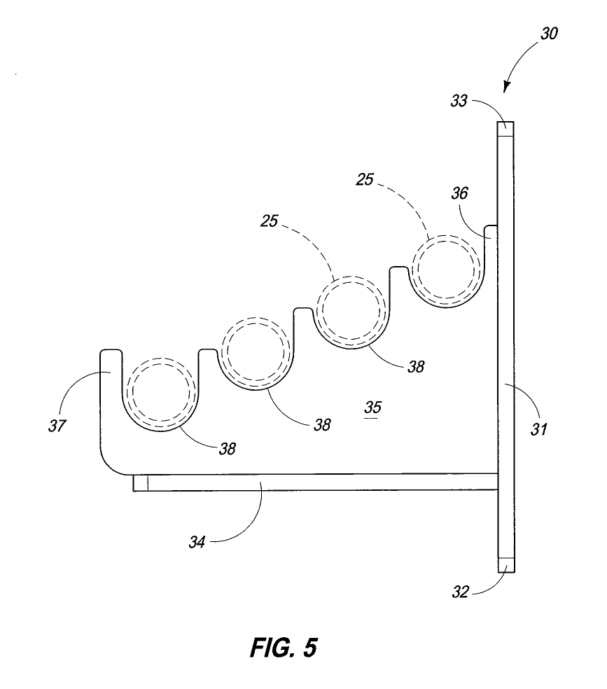

Referring now to FIGS. 5-7, the present form of the invention 1, as seen in these several views, includes an upper portion 30. The upper portion 30 of the invention 1, includes a base 31, for mounting on a supporting surface such as the wall 12, of the animal trailer 10, and wherein the base 31 has a first end 32, and a second end 33. The upper portion 30 further includes a supporting surface 34, which extends generally perpendicularly, outwardly from the base 31, and further is located intermediate the first end 32, and the second end 33 of the base 31. The upper portion 30 further includes an article supporting member 35, and wherein the article supporting member 35 has a proximal end 36 and a distal end 37. The article supporting member is affixed to the base 31, and the supporting surface by using conventional fastening means such as welding, threaded fasteners or the like.

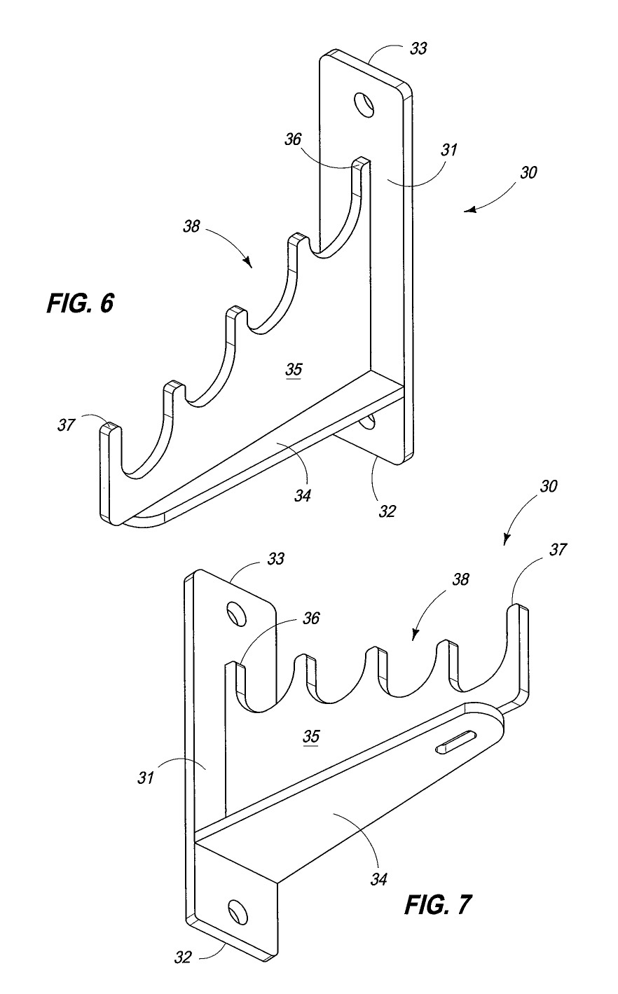

A study of FIGS. 5 and 6, further reveals that the article supporting member 35 has formed therein a multiplicity of semi-circular crenellations 38, which are spaced apart and located intermediate between the proximal end 36 and the distal end 37 of the article supporting member 35. As best shown in FIG. 5, the semi-circular crenellations 38 decrease in elevation, with respect to the supporting surface 34, when measured in a direction extending from the proximal end 36 of the article supporting member 35 to the distal end 37 of the article supporting member 37. In this view the top horizontal members 25 of adjacently positioned corral panel portion 20 are seen in rested mating relation relative to the respective crenellations 38.

As can also best be appreciated from a study of FIGS. 5-7, the semi-circular crenellations 38 are fashioned such that they mimic or imitate the curvature of the tubular metal which is utilized in the fabrication of the top horizontal member 25 of the corral panel portions 20. Further, and as can best be seen in FIG. 8, when the upper portion 30 is mounted in an operational orientation on the rigid sidewall 12 of the animal trailer 10 (for example), the upper portion 30 is located in spaced relation relative to a lower portion 40 of the invention 1, as will be discussed in greater detail, hereinafter. The upper portion 30 is constructed or fabricated from steel, iron, aluminum or similar rigid metallic substrates and which will not significantly distort when loaded with a plurality of corral panel portions 20. Further, the material selected should be resistant to the corrosive effects of the ambient environment.

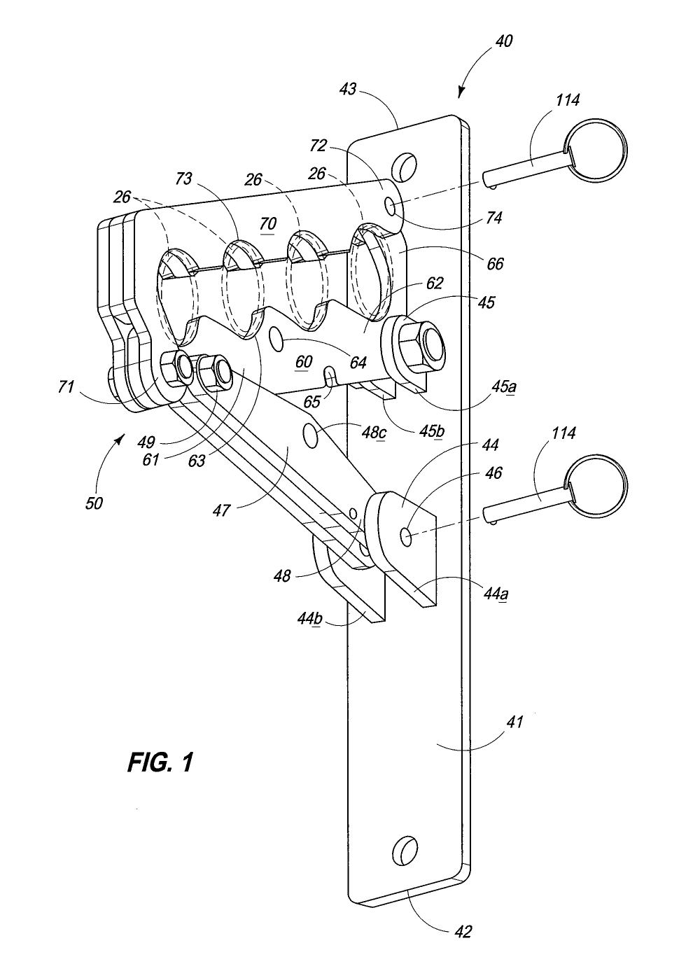

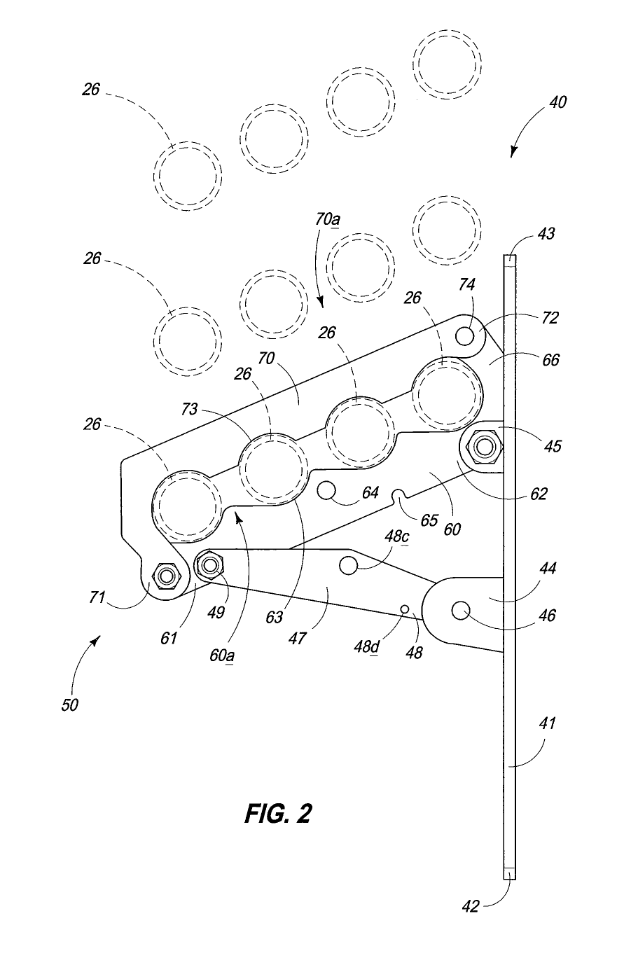

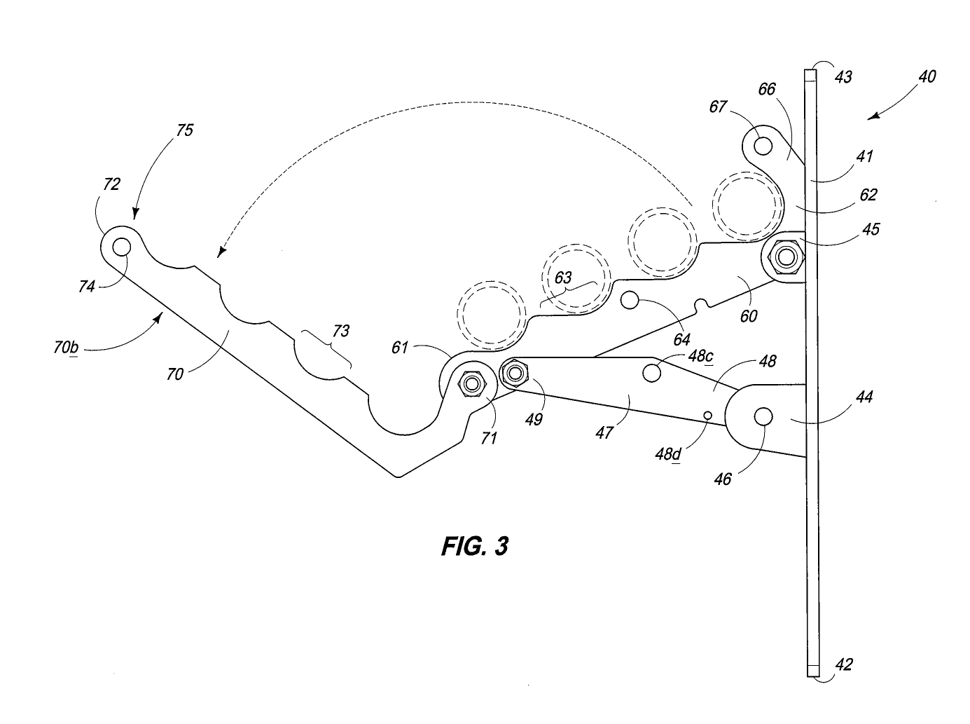

FIGS. 1-4, individually, show a perspective view (in a closed operational position); a side elevation view (in a closed operational position); a side view (in the open position); and a side view (in a storage position), respectively, of the lower portion 40 of the invention 1. As seen in these drawings, the lower portion 40 includes a base 41, for mounting on a supporting surface, such as the wall 12 of the animal trailer 10, and wherein the base 41 has a first end 42 and a second end 43. The lower portion 40 further includes a first mounting member 44, which is attached to the base 41, and which is intermediate the first and second ends 42 and 43, respectively, and a second mounting member 45, which is also attached to the base 41, and which is also located intermediate the first and second ends 42 and 43, respectively. As can best be seen in FIGS. 2 and 3, the first mounting member 44, and the second mounting member 45 are positioned in spaced relation when mounted on the base 41. Each of the mounting members 44 and 45, respectively, have a first portion 44a and 45b; and a second portion 44b and 45b respectively. As best shown in FIG. 1, the first and second portions 44a and 44b; and 45a, and 45b, respectively, are located, in spaced relation, such that the first and second mounting members 44 and 45 can receive and moveably and matingly accommodate, a support arm 47, and an inferior clamp portion 60, as will be described in greater detail, hereinafter. An aperture 46 is formed through the first portions 44a and 45a, and the second portions 44b and 45b, as can best be seen through a study of FIGS. 1 and 2, to permit the support arm 47, and inferior clamp portion 60 to releasably matingly engage each of the mounting members 44 and 45, respectively, as will be described in greater detail hereinafter. It should be appreciated from a study of FIGS. 1 and 2 that the apertures 46 are substantially coaxially aligned between the first and second portions, 44a, 45a, 44b, and 45b, respectively. These coaxially apertures may receive a release pin 114 therethrough. This feature will be discussed in greater detail in the paragraphs which follow.

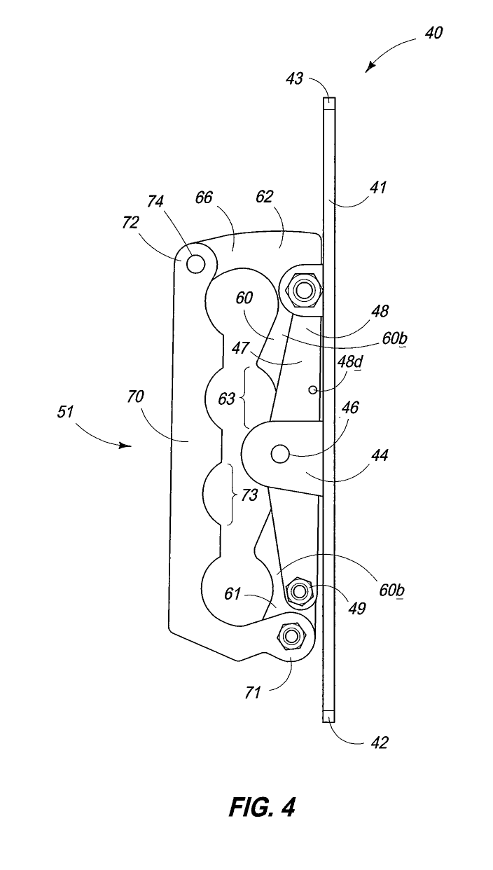

As best illustrated in FIGS. 1-3, the lower portion 40 further includes a support arm 47 which has a first end 48 and a second end 49. The first end 48 of the support arm 47 has an aperture formed therein and which is coaxially aligned with the apertures 46. This allows the support arm 47 to be releasably and pivotally mounted to the first mounting member 44 by using conventional means, such as a cotter pin, threaded bolt or the like 114. Additionally an aperture 48C is provided and which permits the lower portion to be secured in a folded, stored position as seen in FIG. 4. This will also be described in further detail, below.

It should be appreciated from a study of FIGS. 1 and 4 that the support arm 47 is pivotable along a course of travel between two positions, that being, a first, operational position 50, as shown in FIG. 1, and a second, storage position 51, as seen in FIG. 4. When the support arm 47 is in the first, operational position 50, it is located generally perpendicular to the base 41, and is operable to support the inferior clamp portion 60 in a given angular orientation. This can best be seen in FIG. 2. When the support arm 47 is in the second, storage position 51, it is located substantially parallel to the base 41, as can best be seen in FIG. 4. This pivotable feature permits the lower portion 40 to assume an orientation when not in use so as to prevent an animal which is being enclosed by the corral panel portions 20 (not shown) from becoming injured through striking, hooking or brushing against the invention.

Referring now to FIG. 1, the lower portion 40 further includes an inferior clamp portion 60 which has a first end 61, and a second end 62. The first end 61 of the inferior clamp portion 60 is pivotally attached to the second end 49 of the support arm 47 by a suitable fastener. The second end 62 of the inferior clamp portion 60 is releasably, pivotally attached to the second mounting member 45 also by a suitable fastener. As can be seen by a comparison of FIG. 2 and FIG. 4, the inferior clamp portion 60 has a first, operational position 60a (FIG. 2); and a second, storage position 60b (FIG. 4). As can be appreciated from a study of FIGS. 2 and 4, when the inferior clamp portion 60 is in the first, operational position 60a, it is located in an acute, angular orientation relative to the base 41, and is rendered operable to support and secure the corral panel portions 20 and more specifically the spaced, intermediate members 26 thereof and which are shown in phantom lines. When the inferior clamp portion 60 is in the second, storage position 60b it is substantially parallel to the base 41. Similar to that described with respect to the various positions of the support arm 47, the moveable feature of the inferior clamp portion 60 prevents an animal (not shown) which is being enclosed by the corral panel portions 20, from becoming injured through striking, hooking or brushing against the inferior clamp portion 60.

Referring now to FIGS. 1-3 the inferior clamp portion 60 further includes a multiplicity of semi-circular crenellations 63 which are individually located intermediate, and between the first end 61, and the second end 62 of the inferior clamp portion 60. A study of FIGS. 1-3 reveals that the semi-circular crenellations 63 which are formed within the inferior clamp portion 60 are fashioned to mimic or closely imitate the curvature of the intermediate horizontal tubular metal members 26 of the corral panel portions 20 (shown in phantom lines). These crenellations 26 allow the individual corral panel portions 20, and which are suspended by the upper portion 30 to be located in predetermined spaced relation one relative to an adjacent panel portion.

Additionally, the inferior clamp portion 60 has an aperture 64, which is formed therein, and which becomes coaxially aligned with the aperture 48C which is formed in the support arm 47, when the inferior clamp portion 60 is located in the second storage portion 60B as seen in FIG. 4. Where the two apertures are aligned, a locking pin, not shown, can be received through the coaxially aligned apertures thereby securing the invention 1 in the second storage position 60B. Moreover, a cutout region 65 is provided in the inferior clamp portion to accommodate the spacing pin or member 48D (FIG. 2) and which forms a feature of the support arm 47. Moreover, the second end 62 of inferior clamp portion 60 has a coupling portion which is generally indicated by the numeral 66 (FIG. 3), and which has formed therein an aperture 67 which is operable to cooperate with the superior clamp portion as will be described in the paragraphs below.

The lower portion 40 of the present invention 1, further includes a superior clamp portion 70, as can best be seen in FIGS. 1-3. The superior clamp portion 70 has a first end 71, and a second end 72, and wherein the first end 71 of the superior clamp portion 70 is pivotally attached to first end 61 of the inferior clamp portion 60, by a suitable fastener; and wherein the second end 72 of the superior clamp portion 70 is releasably attached to the second end 62 of the inferior clamp portion 60. As can be seen by examining FIGS. 1-4, the superior clamp portion 70 has a multiplicity of semi-circular crenellations 73 formed therein, and which are located intermediate the first end 71, and the second end 72 of the superior clamp portion 70. As seen in FIGS. 1, 3 and 4, an aperture 74 is formed in the second end 72, and is operable to be coaxially aligned with aperture 67 that is formed in the coupling portion 66. In this coaxially aligned orientation, a locking pin 114 can be inserted through same, and thereby secure the second end 72 to the coupling portion 66.

Referring now to FIGS. 2 and 3, it is shown that the superior clamp portion 70 has two operational positions, those being a first, closed, operational position 70a (FIG. 2), and a second, open position 70b (FIG. 3). As can be appreciated from a comparison of FIG. 2 and FIG. 3, the second, open position 70b is located more than about 90 degrees away from the first, closed operational position 70a. Further, when the superior clamp portion 70 is in the first, operational position 70a, the superior clamp portion 70 is located in spaced, immediately superior, and substantially parallel relationship relative to the inferior clamp portion 60 such that the tubular metal of the portable animal corral portions 20 can be secured therebetween, as can best be seen in FIGS. 1, 2 and 8. It should further be appreciated from a study of FIGS. 2 and 3 that when the superior clamp portion 70 is in the second, open position 70b, as shown in FIG. 3, the horizontal, spaced, intermediate members 26 of the corral panel portions 20 are capable of being received into the inferior clamp portion 60. Following the receipt of the horizontal, intermediate members 26 of the corral panel portions 20 into the inferior clamp portion 60, the superior clamp portion 70 can be pivotally moved to the first, closed, operational position 70a such that the horizontal members 26 of the corral panel portions 20 are secured between the inferior clamp portion 60 and the superior clamp portion 70 for transport on the animal trailer 10. As noted, above, when the apertures 74 and 67 are coaxially aligned, a locking pin 114, may be received therethrough and is effective in securing the aforementioned elements together.

### Second Embodiment

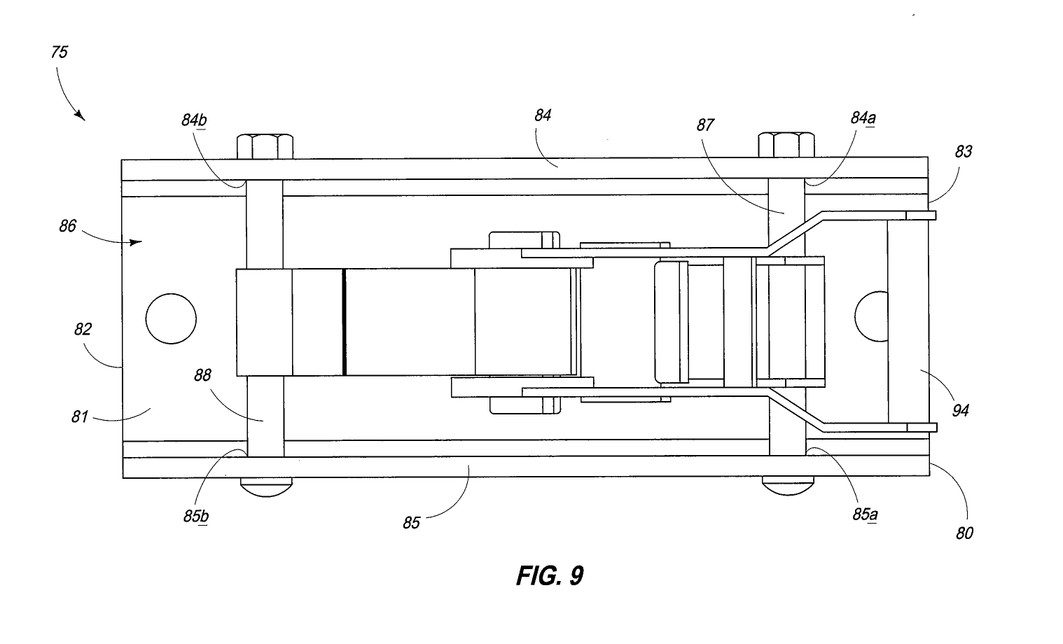

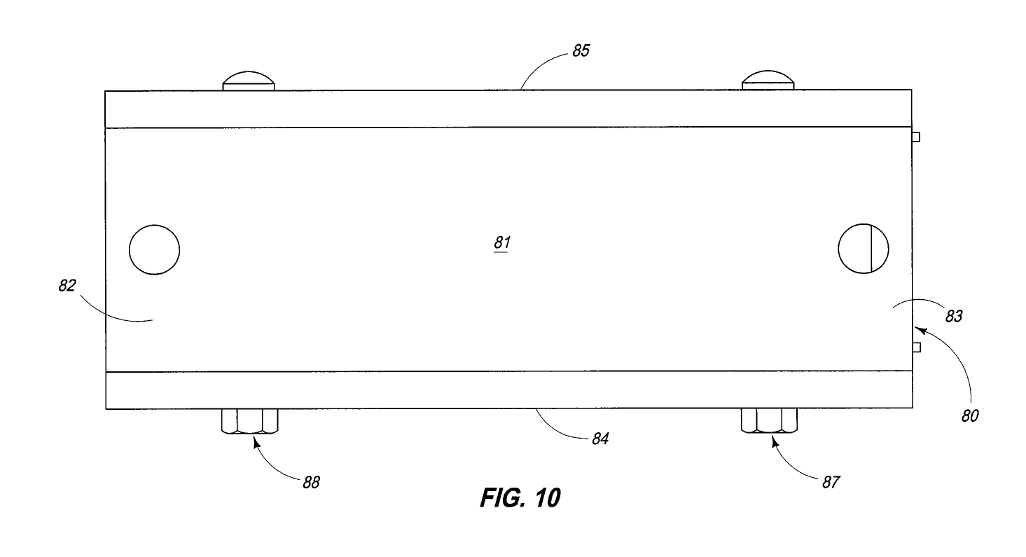

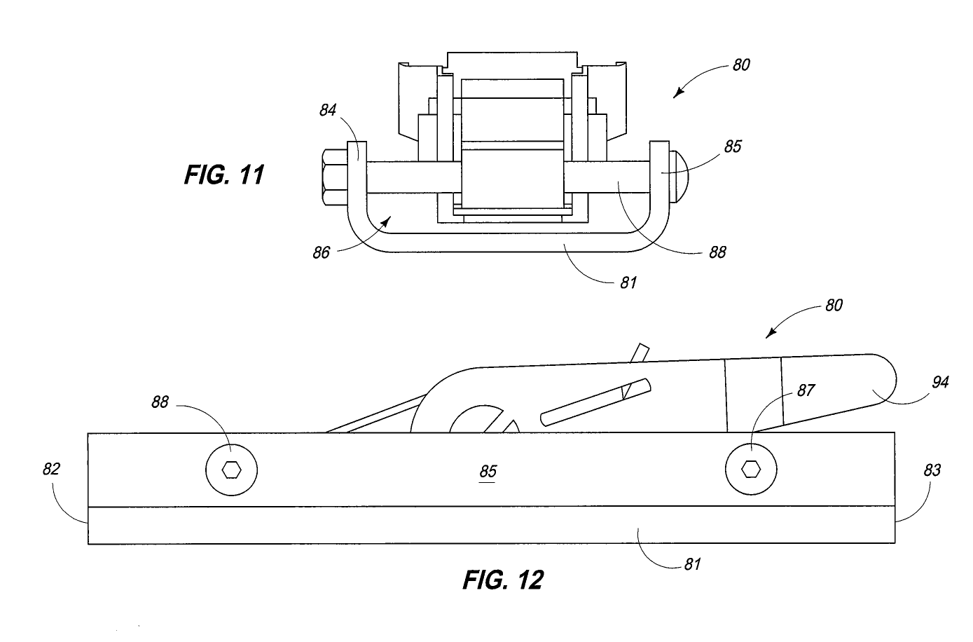

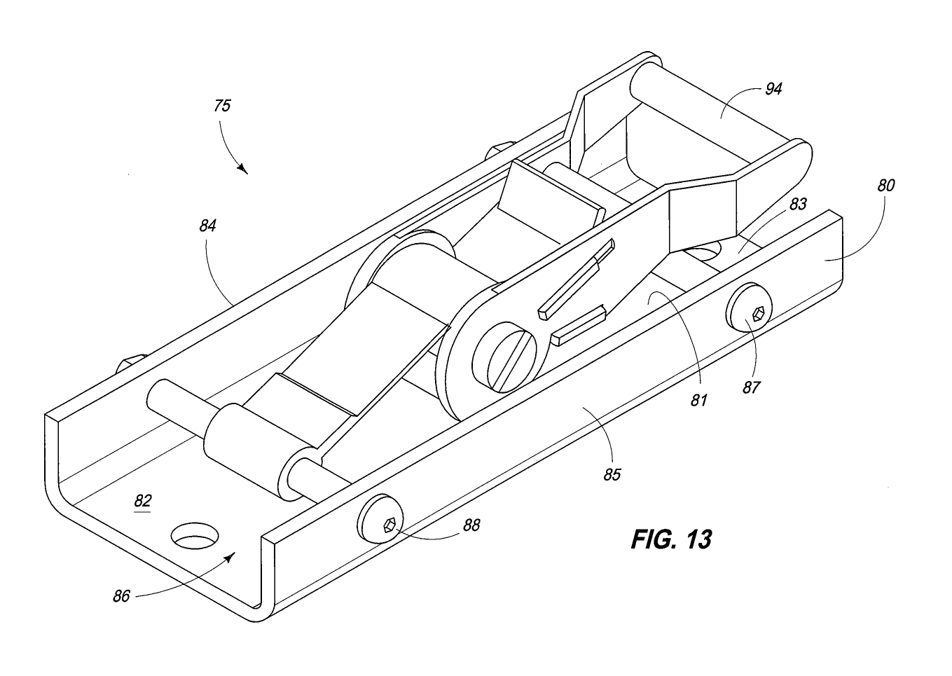

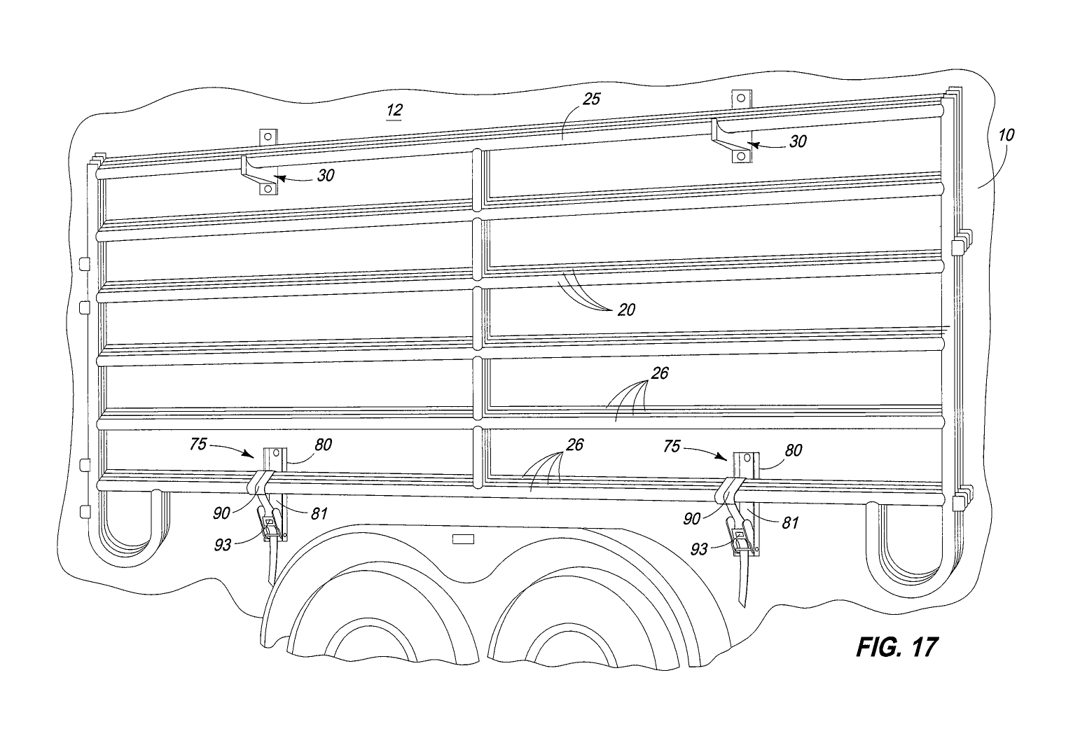

In a second embodiment 75 of the present invention 1, it should be understood that the previously described upper portion 30 remains unchanged. Referring now to FIGS. 9-17 which illustrates this form of the invention mounted on the wall 12 of the trailer, the second form or embodiment of the invention 75, includes a lower portion 80. The lower portion 80 includes a base 81 for mounting on a vertical surface 12. The base 81 has a first end 82, and a second end 83. The lower portion 80 further includes oppositely spaced first and second sidewalls 84 and 85 such that the base 81 and sidewalls 82 and 83 form a C-shaped channel 86. Formed within the first sidewall 84 are apertures 84a and 84b which are located in spaced relation, one relative to the other, and which are further oriented intermediate the first and second ends 82 and 83 of the base 81. Formed within the second sidewall 85 are apertures 85a and 85b which are located in spaced relation, one relative to the other, and further located intermediate the first and second ends 82 and 83 of the base 81. As best shown in FIG. 13, the apertures 84a, and 85a and 84b, 85b are substantially coaxially aligned.

Referring now to FIG. 9, the lower portion 80 further includes a superior support pin 87, and an inferior support pin 88. As best shown in FIGS. 9 and 13, the superior support pin 87 is received in the first pair of substantially coaxially aligned apertures 84a and 85a, and is thereby affixed to the sidewalls 84 and 85. Further, and as best seen in FIGS. 9 and 13, the inferior support pin 88 is received in the second pair of substantially coaxially aligned apertures 84b and 85b and is thus affixed to the sidewalls 84 and 85.

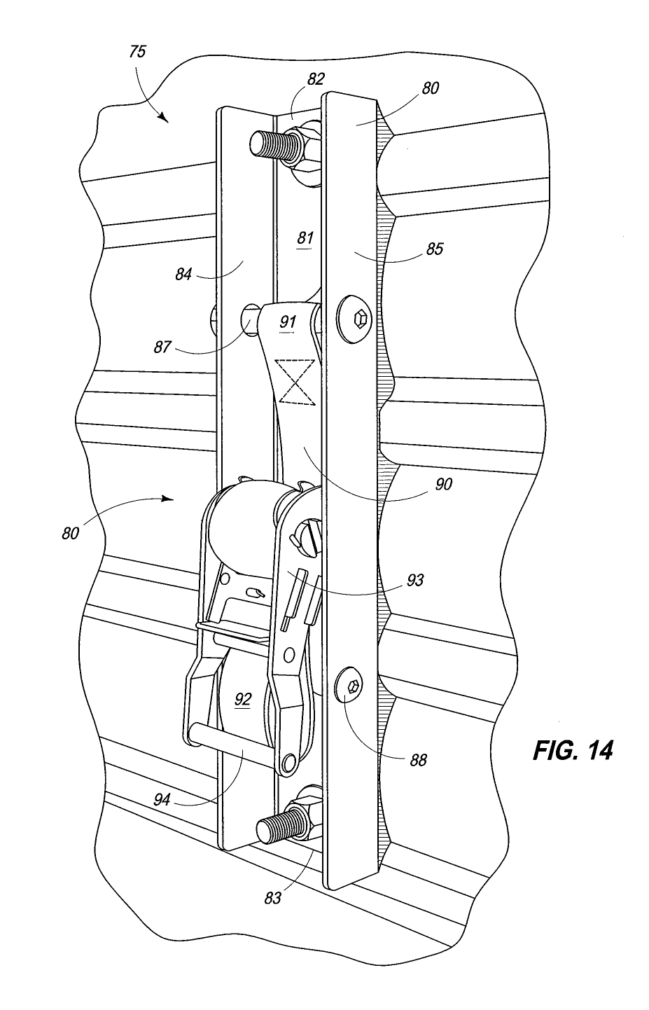

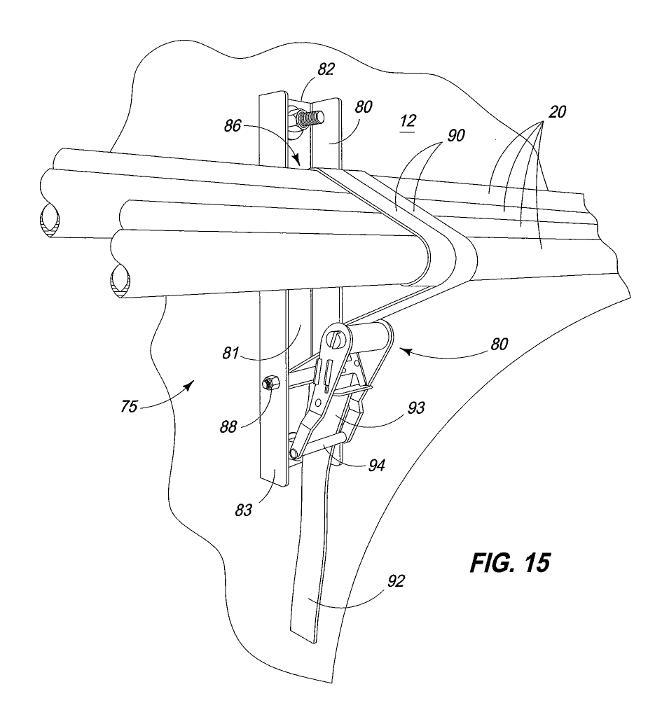

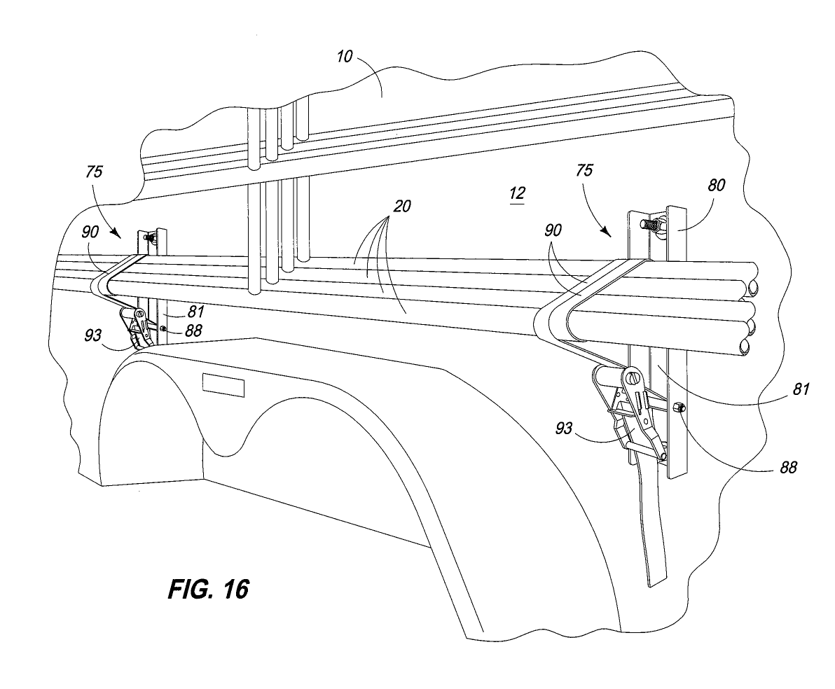

Referring now to FIGS. 14 and 15, the lower portion 80 is depicted in both a storage (FIG. 14), and an operational position (FIG. 15). As will be recognized in the drawings, the lower portion 80, includes an elongated and flexible strap portion 90. The strap portion 90 has a first end 91, and a second end 92. The lower portion 80 structure also includes a ratchet assembly 93. The ratchet assembly 93 may be any one of a number of commercially available ratchet assemblies suitable for the intended purpose of securing a strap and is used to create various amounts of tension on a strap. As can be appreciated from a study of FIG. 14, the first end 91 of the strap portion 90 is affixed to the superior support pin 87 such that, when the ratchet assembly 93 is operated, tension can be imparted to the strap 90 and a desired item such as the individual corral panel portions 20 can be secured with the strap 90 and ratchet 93 between the superior support pin 87 and inferior support pin 88 (FIG. 15). The second end 92 of the strap portion 90 is releasably woven through the ratchet assembly 93 and cooperates with the ratchet portion 93 in a known manner to forcibly engage the article or item to be secured in the lower portion 80. As best shown in FIG. 13, the ratchet assembly 93 includes a handle 94 which is used to increase and decrease the tension applied to the first end 91 of the strap portion 90. FIGS. 15 and 16 depict the second form of the invention in use to secure a multiplicity of corral portions on the side of an animal trailer 10. This form of the invention is particularly useful in transporting variously sized corral panel portions 20, or those corral panel portions which have become bent or distorted, over time during use.

### Third Form

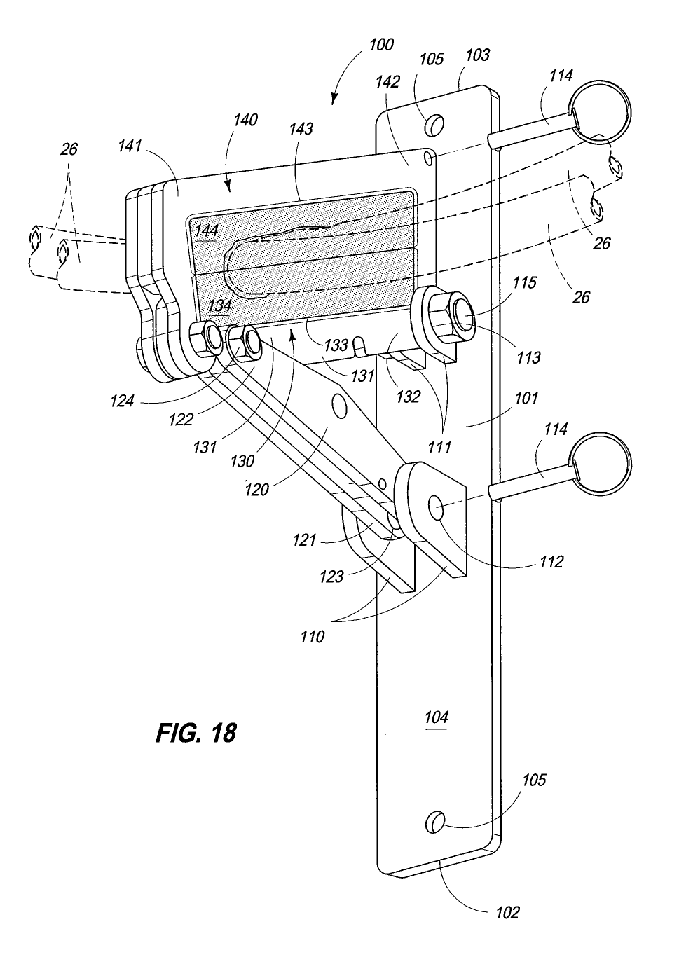

A third form of the invention is generally indicated by the numeral 100 as best seen in FIG. 18. The third form of the invention is similar in some respects to the first two forms of the invention, that being that it utilizes the upper portion 30, the upper portions 30 is used in combination with the structure as seen in FIG. 18. Therefore, for purposes of brevity the structure as seen in the drawings and indicated by the numeral 30 is not further discussed herein. As seen in FIG. 18, the third form of the invention 100 has a base member 101 which is affixed to an underlying supporting surface such as the wall 12 of the animal trail 10, as earlier discussed with respect to the other forms of the invention. The base member has a first end 102, and an opposite, second end 103. The base member further has a top surface 104. Additionally, mounting apertures 105 are formed in the opposite first and second ends, and are operable to receive suitable fasteners (not shown) which are employed to penetrate the underlying supporting surface 12 and secure the base member 101 thereto. Further, the base member 101 can be secured to the underlying supporting surface by other fasteners and means such as welding, and the like. As seen in FIG. 18, the third form of the invention 100 includes a first pair of mounting members which are generally indicated by the number 110, and which are fastened to the top surface 104, and which further extend normally, outwardly, therefrom. The first pair of mounting members 110 are spaced a given distance apart. Further, the third form of the invention 100 includes the second pair of mounting members 111, which again are mounted to the base number 101, and which extend normally outwardly, therefrom, and which are spaced from the first pair of mounting members 110 by a given distance. As seen in FIG. 18, a pair of coaxially aligned apertures 112 are formed in the first pair of mounting members 110. Further a second pair of coaxially aligned apertures 113 are formed in the second pair of mounting members 111. As seen in FIG. 18, the coaxially aligned apertures 112 are operable to receive and matingly cooperate with a removable locking pin 114. Still further, a fastener 115 is operably received through the coaxially aligned apertures 113 to provide rotatable support for the structure which will be discussed in greater detail, below.

As seen in FIG. 18, the third form of the invention 100 includes a support arm 120, which is very similar in structure to that described with respect to numeral 47 as seen in FIG. 1. In this regard the support arm 120 has a first end 121, and an opposite second end 122. An aperture 123 is formed in the first end. Another aperture is formed in the second end 122, but cannot be seen in view of the presence of the fastener 124, which is received therethrough. The support arm 120 is operable to support the inferior clamp portion 130, as will be discussed in the paragraphs which follow.

The third form of the invention 100 includes an inferior clamp portion 130, which is similar in function, to some degree, to the first and second forms of the invention as earlier described. The inferior clamp portion 130 operates to engage and securely support the spaced intermediate, and substantially horizontal members 26, which form a portion of the corral panel portions 20, and which are suspended from the upper portion 30 as described in the earlier drawings. The inferior clamp portion has a first end 131, which is pivotally affixed to the second end 122 of the support arm 120, by means of the fastener 124. Further, the inferior clamp portion has a second end 132, which is pivotally affixed by means of the fastener 115 to the second pair of mounting members 111. As depicted in FIG. 18, the inferior clamp portion has an upwardly facing surface 133 which mounts an elongated resilient engagement member 134, which is typically fabricated of a synthetic, pliable polymeric material which is suitable to engage and then matingly deform, so as to partially wrap around or matingly couple to the spaced intermediate members 26, and which form a part of the corral panel member 20. This element secures them in a substantially fixed orientation relative to the inferior clamp portion 130.

The third form of the invention 100 includes a superior clamp portion 140 which has a first end 141, which is pivotally affixed to the first end 131 of the inferior clamp portion by means of a fastener, as illustrated. Still further, the superior clamp portion has a second end 142, which again, is operable to releasably couple to the second end 132 of the inferior clamp portion in a manner similar to that which was described relative to the first form of the invention. Still further, the superior clamp portion has a downwardly facing surface 143. Further a second, elongated resilient engagement member 144 is provided, which is juxtaposed relative to the first mentioned resilient engagement member 134, when the superior clamp portion 140 is located in predetermined, parallel spaced relation relative to the inferior clamp portion 130. Again, the second resilient engagement member is operable to deform or otherwise matingly engage or conform to the spaced intermediate members 26 of the respective corral panel portions 20, as illustrated, so as to secure the panel portion 20 in an appropriate orientation relative to the inferior clamp portion 130. This form of the invention is particularly useful when employed with corral panel portions 20, which have intermediate, substantially horizontal members 26 that have become distorted or bent through years of use in enclosing animals. As will be recognized, the first form of the invention, as seen in FIG. 1, for example, would not readily accommodate corral panel portions 20 where the intermediate horizontal members have become distorted or otherwise bent in view of the arrangement of that form of the invention. Again, as depicted in FIG. 18, a locking pin 114 is provided, which is operable to engage the second end of 142 of the superior clamp portion 140, and is operable to cooperate with the second end 132 of the inferior clamp portion, thereby securing the superior clamp portion 140 and inferior clamp portion 130, in substantially parallel spaced relation.

### Operation

The operation of the described embodiment of the present invention is believed to be readily apparent and is briefly summarized in this point.

The first form of the mounting bracket 1 of the present invention for supporting an article such as a multiplicity of corral panel portions 20, includes a first base 40, which is mounted on a supporting surface 12 and wherein the first base 40 has a first and second end 42 and 43, respectively; a first mounting member 44 attached to the first base 40; a second mounting member 45 attached to the first base 40, and wherein the second mounting member 45 is located in spaced relation relative to the first mounting member 44; a support arm 47 having first and second end 48 and 49, respectively, and wherein the first end 48 is releasably mounted to the first mounting member 44; an inferior clamp portion 60, having opposite first and second ends 61 and 62, respectively, and wherein the first end 61 is pivotally attached to the second end 49 of the support arm 47, and wherein the second end is releasably attached to the second mounting member 45; a superior clamp portion 70 having opposite first and second ends 71 and 72, and wherein the first end 71 is pivotally attached to the inferior clamp portion 60, and wherein the second end 72 is releasably attached to the second end 62 of the inferior clamp portion 60, and wherein a portion 26 of the article 20 is received between the inferior and superior clamp portions 60 and 70, respectively; a second base 31 mounted on the supporting surface 12, and which is located in spaced relation relative to the first base 41, and wherein the second base has opposite first and second ends 32 and 33, respectively; a supporting surface 34 mounted on the second base 31, and which extends perpendicularly outwardly relative thereto, and wherein the supporting surface 34 is located intermediate to first and second ends 32 and 33 of the second base 31; and an article supporting member 35, having a first proximal end 36 and a second distal end 37, and which is mounted on the second base 31 and to the supporting surface 34, and wherein a portion, that being the top horizontal member 25, of the corral panel portion 20, is supported on the article support member 35. A second form of the invention is seen in FIGS. 9 through 17, respectively, and wherein the second form of the invention is generally indicated by the numeral 75, and includes a lower portion 80, which is utilized with same, and which employs an arrangement that utilizes an elongated flexible strap portion 90, which cooperates with a ratchet assembly 93. The strap portion 90 is employed to wrap or otherwise forcibly engage one of the spaced intermediate members 26 which forms a portion of the corral panel portion 20, and the ratchet assembly is operable to exert force on the strap, thereby securing the corral panel portions 20 in an appropriate, hanging orientation on the side of the supporting surface as depicted herein, that being the wall 12 of the animal trailer 10.

In a third possible form of the invention 100, as seen in FIG. 18, the present invention includes a novel lower member 101, which has features similar to that seen with respect to the first form of the invention 1. However in the third form of the invention, the inferior clamp portion 130, as well as the superior clamp portion 140, utilize elongated resilient engagement members 134 and 144, respectively, which distort or otherwise mold to the spaced intermediate members 26 of the corral panel portion 20 when they are received therebetween the inferior clamp portion 130 and the superior clamp portion 140. In this arrangement, the third form of the invention 100 provides a convenient means for securing corral panel portions 20, which may have portions which have become distorted or bent due to long use or as a result of an animal engaging same and bending it, thereby allowing the invention to find great utilization with corral panel portions that may have various shapes.

Therefore, it will be seen that the present invention which includes upper and lower portions 30,40, 80 and 100, respectively, provides many advantages over the prior art devices and other assemblies which have been utilized in the past to mount and transport portable animal corral panel portions 20 as depicted in the drawings. Further, the present invention is small, compact and capable of being mounted on a variety of vertical supporting surfaces, such as animal trailers 10, overland vehicles and barns. Moreover, the present invention is capable of being compactly stored when not in use such that an animal being enclosed by the corral panel portions 20 will not become injured through striking, hooking or accidentally brushing against the invention as they move about the corral.

In compliance with the statute, the invention has been described in language more or less specific as to structural and methodological features. It is to be understood, however, that the invention is not limited to the specific features shown and described, so means herein disclosed comprise preferred forms of putting the invention into effect. The invention is, therefore, claimed in any of its forms or modifications within the proper scope of the appended claims appropriately interpreted in accordance with the Doctrine of Equivalence.

What I claim is:

1. A mounting bracket for supporting an article, comprising:
a first base which is mounted on a supporting surface, and wherein the first base has a first end and a second end;
a first mounting member attached to the first base;
a second mounting member attached to the first base, and wherein the second mounting member is located in spaced relation relative to the first mounting member;
a support arm having a first end and a second end, and wherein the first end is releasably mounted to the first mounting member;
an inferior clamp portion having a first end and a second end, and wherein the first end is pivotally attached to the second end of the support arm, and wherein the second end is releasably attached to the second mounting member;
a superior clamp portion having a first and a second end, and wherein the first end is pivotally attached to the first end of the inferior clamp portion, and wherein the second end is releasably attached to the second end of the inferior clamp portion, and wherein a portion of the article is received between the inferior and superior clamp portions;
a second base mounted on the supporting surface, and in spaced relation relative to the first base, and wherein the second base has opposite first and second ends;
a supporting surface mounted on the second base and which extends perpendicularly outwardly relative thereto, and wherein the supporting surface is located intermediate the first and second ends of the second base; and
an article supporting member having a proximal and a distal end, and which is mounted on the second base, and to the supporting surface and wherein a portion of the article is supported on the article supporting member.

2. A mounting bracket, as claimed in claim 1, and wherein the first mounting member has a first portion and a second portion, and wherein an aperture is formed through the first portion and the second portion, and wherein the respective apertures are substantially coaxial aligned between the first portion and the second portion.

3. A mounting bracket as claimed in claim 1, and wherein the second mounting member has a first portion and a second portion, and wherein an aperture is formed through the first portion and the second portion, and wherein the respective apertures are substantially coaxial aligned between the first portion and the second portion.

4. A mounting bracket as claimed in claim 1, and wherein the support arm is moveable between a first position and a second position, and wherein, when in the first position, the support arm is substantially perpendicular relative to the first base, and wherein when located in the second position the support arm is substantially parallel to the first base.

5. A mounting bracket as claimed in claim 1, and wherein the support arm when located in the first position is operable to substantially support the inferior and superior clamp portions in a given orientation relative to the first base.

6. A mounting bracket as claimed in claim 1, and wherein the inferior clamp portion has a first position and a second position, and wherein when located in the first position, the inferior clamp portion is oriented in an acute angular, spaced relationship relative to the first base, and wherein when located in the second position, the inferior clamp portion is substantially parallel to the first base.

7. A mounting bracket as claimed in claim 1, and wherein the inferior clamp portion has at least one semi-circular crenellation which is spaced intermediate, the first and second ends of the inferior clamp portion.

8. A mounting bracket as claimed in claim 1, and wherein the superior and inferior clamp portions mount an elongated resilient member, which is operable to matingly, conformably engage the article.

9. A mounting bracket as claimed in claim 7, and wherein the superior clamp portion is moveable between a first position and a second position, and wherein, when located in the first position, the superior clamp portion is spaced immediately superior and substantially parallel to the inferior clamp portion, and wherein when located in the second position, the superior clamp portion is located about 180 degrees from the first position thereof.

10. A mounting bracket as claimed in claim 9, and wherein the superior clamp portion has at least one semi-circular crenellation which is spaced intermediate the first and second ends of the superior clamp portion.

11. A mounting bracket as claimed in claim 10, and wherein when the superior clamp portion is located in the first position the at least one semi-circular crenellation of the superior clamp is located immediately superior to the at least one semi-circular crenellation of the inferior clamp portion such that a circular opening is defined, and which has a predetermined diameter.

12. A mounting bracket as claimed in claim 7, and wherein the article supporting member has formed therein a multiplicity of semi-circular crenellations spaced intermediate the proximal and distal ends of the article supporting member, and wherein the relative elevations of the semi-circular crenellations, with respect to the supporting surface which is mounted on the second base, decrease when measured in a direction extending from the proximal end of the article supporting member to the distal end of the article supporting member.

13. A mounting bracket as claimed in claim 8, and wherein the respective elongated resilient members are juxtaposed when the superior and inferior clamp portions are oriented in substantially parallel relationship, one relative to the other.

14. A mounting bracket for supporting an article, comprising:
an article supporting member for releasably securing an article at a predetermined location on an overland vehicle;
a first mounting member affixed on the overland vehicle;
a second mounting member affixed on the overland vehicle, and wherein the second mounting member is located in spaced relation relative to the first mounting member;
an inferior clamp portion pivotally mounted to the second mounting member and which secures the article in spaced relation relative to the article supporting member;
a superior clamp portion pivotally mounted on the inferior clamp portion and which secures the article in spaced relation relative to the article supporting member; and
a support arm for maintaining the superior and inferior clamp portions in a predetermined first position or a second position.

15. A mounting bracket, as claimed in claim 14, and wherein the article supporting member has a proximal end and a distal end, and wherein a multiplicity of individual semi-circular crenellations are formed in the article supporting member and are located between the proximal and distal ends thereof.

16. A mounting bracket as claimed in claim 14 and wherein a resilient member is mounted on each of the respective superior and inferior clamp portions and which secure the article.

17. A mounting bracket, as claimed in claim 15, and wherein when the article supporting member is mounted on a substantially vertically oriented surface of the overland vehicle, and wherein the semi-circular crenellations decrease in elevation, relative to a surface of the earth, when measured in a direction extending from the proximal to the distal ends thereof.

18. A mounting bracket, as claimed in claim 14, and wherein the first mounting member has a first portion and a second portion.

19. A mounting bracket as claimed in claim 18, and wherein an aperture is formed through the first portion and the second portion, and wherein the respective apertures are substantially coaxial aligned.

20. A mounting bracket as claimed in claim 14, and wherein the second mounting member has a first portion and a second portion.

21. A mounting bracket as claimed in claim 20, and wherein an aperture is formed through the first portion and the second portion, and wherein the respective apertures are substantially coaxial aligned.

22. A mounting bracket as claimed in claim 14, and wherein the support arm has a first end and a second end, and wherein the first end is releasably attached to the first mounting member and wherein the second end is pivotally attached to the inferior clamp portion.

23. A mounting bracket as claimed in claim 22, and wherein the support arm is moveable between a first position and a second position, and wherein when located in the first position, the support arm is substantially perpendicular to the first mounting member, and wherein when located in the second position the support arm is substantially parallel to the first mounting member.

24. A mounting bracket as claimed in claim 14, and wherein the inferior clamp portion has a first end and a second end, and wherein the first end is pivotally attached to the second end of the support arm, and wherein the second end is releasably attached to the second mounting member.

25. A mounting bracket as claimed in claim 24, and wherein the inferior clamp portion has at least one semi-circular crenellation which is located intermediate the first end and the second end.

26. A mounting bracket as claimed in claim 24, and wherein the inferior clamp portion is movable between a first position, and a second position, and wherein when located in the first position the inferior clamp portion is oriented in an acute, angular relationship relative to the first mounting member, and wherein when located in the second position the inferior clamp portion is oriented substantially parallel to the first mounting member.

27. A mounting bracket as claimed in claim 14, and wherein the superior clamp portion has a first end and a second end, and wherein the first end is pivotally attached to the second end of the inferior clamp portion.

28. A mounting bracket as claimed in claim 27, and wherein the superior clamp portion has formed therein at least one semi-circular crenellation which is spaced intermediate the first and second ends of the superior clamp portion.

29. A mounting bracket as claimed in claim 27, and wherein the superior clamp portion has a first position and a second position, and wherein, when located in the first position, the superior clamp portion is immediately superior and substantially parallel to the inferior clamp portion, and wherein when located in the first position the second end of the superior clamp portion is releasably attached to the second end of the inferior clamp portion, and wherein the second position of the superior clamp portion is about 180 degrees offset relative to the first position of the superior clamp portion.

30. A mounting bracket as claimed in claim 27, and wherein, when the superior clamp portion is in the first position, the at least one semi-circular crenellation of the superior clamp portion is located immediately superior to the at least one semi-circular crenellation of the inferior clamp portion such that a substantial circular opening is created, and wherein the circular opening has a predetermined diameter which accommodates a portion of the article.

31. A mounting bracket for supporting an article, comprising:
a first base, having a first and a second end;
a first mounting member, mounted on the first base and which is located intermediate the first and second ends thereof, and wherein the first mounting member has a first portion and a second portion;
a second mounting member, mounted on the first base and which is located intermediate the first and second ends of the first base and which is further located in spaced relation relative to the first mounting member, and wherein the second mounting member has a first portion and a second portion;
a support arm having a first end and a second end and wherein first end is pivotally mounted on the first mounting member;
an inferior clamp portion having a first end and a second end, and wherein the inferior clamp portion receives an article to be supported and is pivotally mounted to the second end of the support arm;
a superior clamp portion, having a first end and a second end, and wherein the superior clamp portion secures in a predetermined position the article to be supported and wherein the first end of the superior clamp portion is pivotally mounted on the second end of the support arm;
a second base having a first end, and a second end, and wherein the second base is in located spaced relation relative to the first base;
a supporting surface which is mounted on the second base and which is further located intermediate the first and second ends of the second base, and which further extends substantially perpendicularly, outwardly relative thereto; and
an article supporting member, which is mounted on the second base and which is located intermediate the first and second ends of the second base, and which is further mounted to the supporting surface, and wherein a portion of the article supporting member supports the article.

32. A mounting bracket as claimed in claim 31, and wherein the first portion and the second portion of the first mounting member have an aperture formed therein, and wherein the respective apertures are coaxial aligned, one relative to the other, and wherein a fastener is received through the coaxially aligned apertures.

33. A mounting bracket as claimed in claim 31, and wherein the first portion and the second portion of the second mounting member have an aperture formed therein, and wherein the respective apertures are coaxial aligned, one relative to the other, and wherein a fastener is received through the coaxially aligned apertures.

34. A mounting bracket as claimed in claim 31, and wherein first end of the support arm is releasably attached by the fastener to the first mounting member, and wherein the second end of the support arm is pivotally attached to the inferior clamp portion, and wherein the support arm has a first position and a second position, and wherein when the support arm is located in the first position the support arm is substantially perpendicular relative to the first base, and wherein when the support arm is located in the second position the support arm is substantially parallel to the first base.

35. A mounting bracket as claimed in claim 31, and wherein the first end of the inferior clamp portion is pivotally attached to the second end of the support arm, and wherein the second end of the inferior clamp portion is releasably attached by the fastener to the second mounting member.

36. A mounting bracket as claimed in claim 31, and wherein the inferior clamp portion has a first position and a second position, and wherein when located in the first position the inferior clamp portion is substantially perpendicular to the first base, and wherein when the inferior clamp portion is located in the second position the inferior clamp portion is substantially parallel to the first base.

37. A mounting bracket as claimed in claim 31, and wherein inferior clamp portion has formed therein at least one semi-circular crenellation which is located in spaced intermediate relation relative to the first and second ends of the inferior clamp portion.

38. A mounting bracket as claimed in claim 31, and wherein a resiliently deformable member is mounted on each of superior and inferior clamp portions, and which both engage the article.

39. A mounting bracket as claimed in claim 31, and wherein the first end of the superior clamp portion is pivotally attached to the first end of the inferior clamp portion, and wherein the second end of the superior clamp portion is releasably attached to the second end of the inferior clamp portion and the second mounting member.

40. A mounting bracket as claimed in claim 31, and wherein the superior clamp portion has a first position and a second position, and wherein when located in the first position the superior clamp portion is located substantially immediately superior and substantially parallel to the inferior clamp portion, and wherein when located in the second position the superior clamp portion is located about 180 degrees from the first position.

41. A mounting bracket as claimed in claim 31, and wherein the superior clamp portion has formed therein at least one semi-circular crenellation which is located intermediate the first and second ends of the superior clamp portion.

42. A mounting bracket as claimed in claim 31, and wherein when located in the first position the at least one semi-circular crenellation of the superior clamp portion is located immediately superior to the at least one semi-circular crenellation of the inferior clamp portion such that a circular opening is created, and wherein the circular opening has a predetermined diameter.

43. A mounting bracket for securing an article, comprising:
a base which is mounted on a supporting surface and wherein the base has a first and second end and a first sidewall and a second sidewall;
a superior support pin engaging the first and second sidewall;
an inferior support pin engaging the first and second sidewall, and wherein the inferior support pin is spaced from the superior support pin;
a strap portion having a first end, and a second end, and wherein the first end of strap portion is coupled to the superior support pin; and
a ratchet assembly affixed to the inferior support pin, and wherein the second end of the strap releasably cooperates with ratchet assembly and forcibly engages the articles.

44. A mounting bracket as claimed in claim 43, and wherein the first sidewall has a first end and a second end, and wherein the first sidewall has a first pair of apertures formed therein; and wherein the apertures are located in spaced relation one relative to the other.

45. A mounting bracket as claimed in claim 40, and wherein the second sidewall has a first end, and a second end, and wherein the second sidewall has a second pair of apertures formed therein; and wherein the second pair of apertures are located in spaced relation one relative to the other.

46. A mounting bracket as claimed in claim 45, and wherein the pair of apertures formed in the respective first and second sidewalls are substantially coaxially aligned.

47. A mounting bracket as claimed in claim 46, and wherein the superior support pin is received in one of the coaxially aligned apertures which are formed in the first and second sidewalls.

48. A mounting bracket as claimed in claim 47, and wherein the inferior support pin is received in the other of the coaxially aligned apertures which are formed in the first and second sidewalls.

49. A mounting bracket as claimed in claim 48, and wherein the second end of the first strap portion is releasably woven through the ratchet assembly.

50. A mounting bracket as claimed in claim 44, and wherein the ratchet assembly has a handle portion, and wherein the handle portion is inoperable to increase and decrease the tension applied to the strap portion when a force is applied to same.

51. A mounting bracket for securing an article, comprising:
a base which is mounted on a supporting surface and wherein the base has a first and second end and a first sidewall and a second sidewall;
a superior support pin engaging both of the first and second sidewalls;
an inferior support pin engaging both of the first and second sidewalls and wherein the superior and inferior support pins are located in substantially parallel spaced relation on relative to the other;
a strap portion having a first end and a second end, and wherein the first end of the strap is coupled to the superior support pin; and
a ratchet assembly affixed to the inferior support pin, and wherein the second end of the strap releasably cooperates with ratchet assembly and forcibly engages an article.

52. A mounting bracket as claimed in claim 51, and wherein the second end of the first strap portion is releasably woven through the ratchet assembly.

53. A mounting bracket as claimed in claim 51, and wherein the ratchet assembly has a handle portion, and wherein the handle portion increases and decreases the tension applied to the first strap portion when force is applied to same.
